(19) United States
(12) Patent Application Publication
(10) Pub. No.: US 2017/0178154 A1
(43) Pub. Date: Jun. 22, 2017

(54) LEVERAGING NETWORK-BASED POINT TO POINT TRANSACTIONS

(71) Applicant: SAP SE, Walldorf (DE)

(72) Inventors: Joerg Wegener, Nussloch (DE); Michael Spengler, Heidelberg (DE)

(21) Appl. No.: 14/978,025

(22) Filed: Dec. 22, 2015

(51) Int. Cl. G06Q 30/02; H04L 29/06

(52) U.S. Cl. CPC G06Q 30/0201; H04L 63/0421

(57) ABSTRACT

A method, system, and computer-readable medium to provide a service to members enrolled with the service, the method including obtaining non-public transaction information concerning transactions between business trading entities belonging to a networked platform, the non-public transaction information including details of, at least, buying and selling of goods and services between the entities; storing the non-public transaction information in a centrally accessible storage facility; anonymizing the non-public transaction information; analyze the non-public transaction information based on, at least, an aggregation of the non-public transaction information; and delivering a record of the analysis to members of a business network.

Some business computing systems, applications, and services manage, store, and perform queries on vast amounts of data (i.e., “big data”). In some instances, business partners may conduct business transactions using a networked business platform, wherein the data is maintained within the networked business platform. While the business entities may belong to the networked business platform for one or more specific purposes (e.g., procurement processing), additional or other purposes might be achieved based on the vast collection of big data within the networked business platform.

### BRIEF DESCRIPTION OF THE DRAWINGS

FIG. 1 is an illustrative schematic flow of a traditional process;

FIG. 2 is an illustrative schematic flow of a process, in accordance with some embodiments herein;

FIG. 3 is a flow diagram of a process, according to some embodiments;

FIG. 4 is an illustrative depiction of a platform to supports some processes and systems, in accordance with some embodiments herein; and

FIG. 5 is a block diagram of a system according to some embodiments.

### DETAILED DESCRIPTION

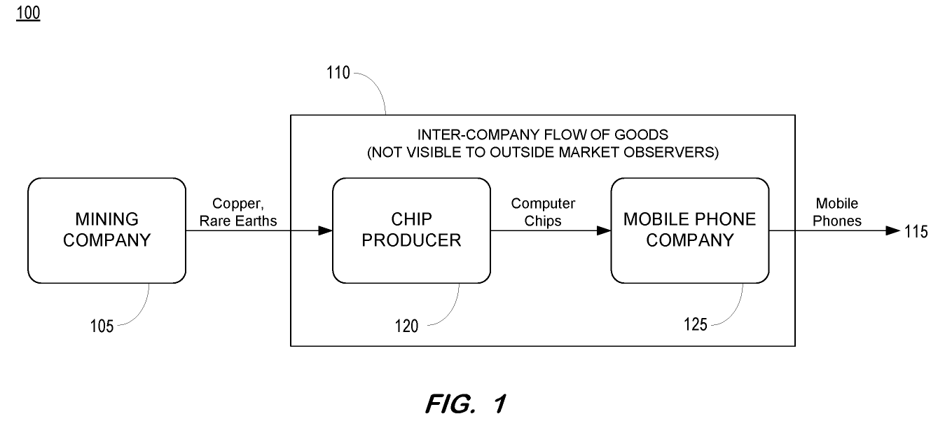

Some embodiments herein are associated with methods and systems for leveraging data related to network-based point-to-point or business-to-business (B2B) transactions. FIG. 1 is an illustrative schematic flow 100 of information related to some business partners and entities associated with each other in some types of traditional or conventional relationships. In the example of FIG. 1, process 100 relates to operations for producing a mobile telephone that will be offered for sale. For sake of clarity and to highlight certain aspects of the flow of information of process 100, all of the many different operations related to bringing a mobile phone to market are not shown in FIG. 1. The operations shown in FIG. 1 will however highlight some of the aspects relevant to the present disclosure. For example, when a company decides to produce a quantity of mobile phones to sale, it places orders with the equipment and component manufacturers in order to procure the requisite components needed to produce the mobile phone. In response to the mobile device seller's, for example, initial act of placing orders with other businesses for components to produce the desired quantity of mobile phones, raw materials used by the equipment and component manufacturers are bought from a mining company 105. The raw materials to produce, for example, integrated circuit (IC) chips of the mobile phone are sold to a chip producer 120. The chip producer may sell the IC chips they produce (e.g., microprocessors, digital signal processors, mobile frequency radios, etc.) to the mobile phone producing company 125. The mobile phone producing company 125 can then assemble the mobile phone with the various components forming the device, including the components it has purchased, at least in part, from other businesses. Thereafter, the mobile phone producing company 125 can sell the mobile phones to the public and/or other resellers for sale to the public and others at 115.

Taking an overview of process 100, only a limited amount of the transactions between the business entities conducting transactions in the chain of events needed to bring a mobile phone to market may be exposed (i.e., public) to the greater marketplace. Instead, a number of the transactions or operations involved in the process are private, non-public transactions occurring privately between the businesses directly involved in the transactions (i.e., the buying and selling of the various goods and services) used in bringing the mobile phone to market. For example, in the simplified example of FIG. 1, the amount of materials sold by the mining company at 105 may be ascertained by or visible to outside market observers when the chip manufacturers buy the raw materials (copper, rare earths, etc.) in response to orders for mobile phone components. Likewise, the quantity of mobile devices offered for sale in the marketplace at 115 may be determined from publically available information. However, the numerous transactions between the business entities at 110, including but not limited to transactions between the chip producer 120 and the mobile phone company 125 (others not shown in FIG. 1) are generally not visible to market observers outside of the business entities.

Given that a number of transactions between business entities involved in business process may not be visible to market observers outside of the business entities directly involved in the transactions, market observers and others (e.g., competitors of the business entities involved in the B2B transactions at 110) may be limited in making intelligent decisions due to the lack of transparency regarding all of the transactions involved in a typical business process involving more than one business entity.

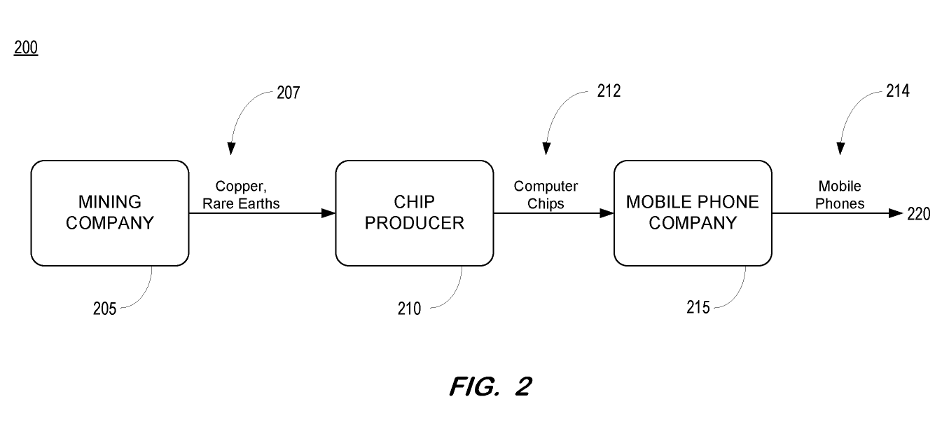

FIG. 2 is an illustrative schematic depiction of a process flow 200, in accordance with some embodiments herein. Process 200 is an illustrative depiction of the information made visible (i.e., transparent) to business entities, in accordance with some embodiments herein. In some embodiments, the business entities participating in process 200 may be members of a particular networked platform. The particular networked platform can have access to all of the transactions between the business entities belonging thereto. Knowledge of all of the transactions between the business entities belonging to the particular networked platform may, in some embodiments herein, be leveraged and used to make informed, intelligent business decisions.

In some aspects, business entities and others that may be granted access to all of the transactions between the business entities and/or informed of an analysis (e.g. a forecast) of the business transactions may be able to make decisions before the effects of the business transactions are seen in the marketplace and observed by outside market observers. In this manner, the business entities and others granted access to information regarding all of the transactions between the business entities may make business decisions based on real-time market impact information.

Referring to FIG. 2, mobile phone producer 215 may decide to reduce production of mobile phones in an upcoming quarter. Such a decision may result in the mobile phone producer 215 reducing the number of chip orders it places with chip producer 210. Accordingly, chip producer 210 will sell/supply fewer chips to mobile phone producer 215 at 212. Additionally, chip producer 210 may reduce the amount of raw materials it orders from mining company 205. Thus, there may be a reduction in raw material sales to chip producer 210 at 207.

In the example of FIG. 2, the details of the B2B transactions at 207 and 212 may be seen, observed, and/or reported to members of business network herein, in accordance with some embodiments. In some embodiments, this detailed information regarding the transactions is made available to members of the business network. In some embodiments, the detailed information regarding the transactions may be limited in its availability only to those members that consent to sharing details regarding transactions to which they are a party. As illustrated by FIG. 2, the members of the business network thereof are afforded greater access and/or knowledge of the information related to the transactions between the business entities participating in process 200, as compared to process 100 of FIG. 1. For example, the members of the business network of FIG. 2 can access more information than just the eventual quantity of mobile phones 214 for sale in the marketplace 220.

In some instances, a business entity may opt-in (or opt-out) of participating in the sharing of detailed transaction information between business entities belonging to the business network. In some embodiments, incentives may be offered to the business network members in an effort to encourage their participation in the sharing of detailed transaction information between the members of the business network. An incentive may take on many forms, including monetary and non-monetary configurations.

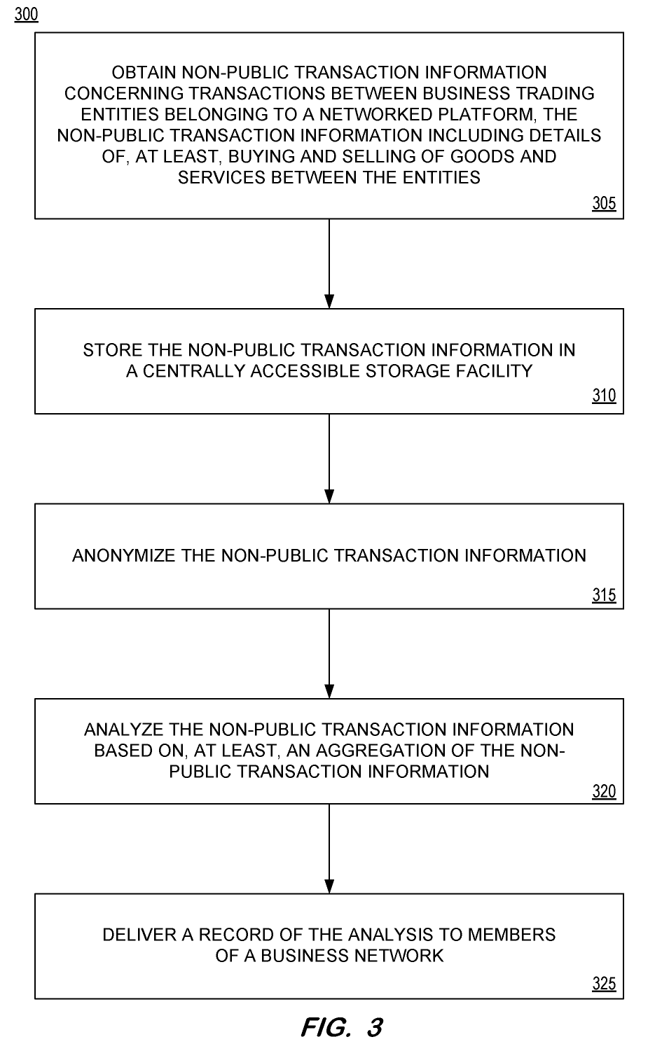

FIG. 3 is an illustrative depiction of a flow diagram for a process 300, in accordance with some embodiments herein. Process 300 is shown starting with an initial operation of 305. In some embodiments, one or more operations may occur before operation 305 that, at least in part, facilitate the execution of process 300. For example, an operation to enroll businesses in a networked platform herein and/or migrate their operations to systems, devices, and services such that the details of the business's transactions with other members of the networked platform can be captured by the business network may occur before operation 305.

At operation 305, non-public transaction information concerning transactions between business trading entities belonging to a networked platform is obtained. The non-public transaction information may include details of, at least, buying and selling of goods and services between the entities. In some aspects, the details can include specific information that is used to buy and sell those goods and services, including details captured in business documents used to effectuate, for example, a procurement process. In some aspects, the non-public transaction information obtained as part of operation 305 does not create additional burdens or requirements on the business entities since the business entities are already members or participants in the networked platform and the details are a consequence of their on-going business transactions.

Operation 310 includes storing the non-public transaction information in a centrally accessible storage facility. The storage facility may include a device, system, or service. In some embodiments, the non-public transaction information may be stored and managed by a database managements system. In some embodiments, the non-public transaction information may be stored and managed by an in-memory database, where the data is stored as one or more structured unstructured, object-based, and other configurations and data structures.

Proceeding to operation 315, process 300 includes anonymizing the non-public transaction information. The non-public transaction information may be made anonymous to remove specific identifying aspects of the business entities involved in the transactions relating thereto. The anonymizing the non-public transaction information may, in some respects, encourage business entities to participate in sharing the details of the transactions to which they are a party. Different techniques and process may be used to make the non-public transaction information anonymous, without any loss of generality.

At operation 320. the non-public transaction information may be analyzed. The analyzing of the non-public transaction information can be based on, at least, an aggregation of the non-public transaction information. In some aspects, the non-public transaction information may relate to thousands of business entities and millions or even billions of transactions. Accordingly, the non-public transaction information can fairly be referred to as “big data”. The non-public transaction information big data may be aggregated and analyzed in an effort to gain insights into the business processes and transactions. In some embodiments, the analyzing can include, for example, data mining, pattern recognition, forecasting, and other types of data analysis processes. In some embodiments, additional information, including, for example, publically available market data, can be combined with the -public transaction information as part of the analyzing of operation 320.

Process 300 continues to operation 325 where a record of the analysis of operation 320 is delivered to members of a business network. The business network may include all or some of the business entities participating in the networked platform. In some instances, the business entities participating in the business network of operation 325 may be a subset of the business entities that are members or participants in the networked platform of operation 305 that relate to the non-public transaction information.

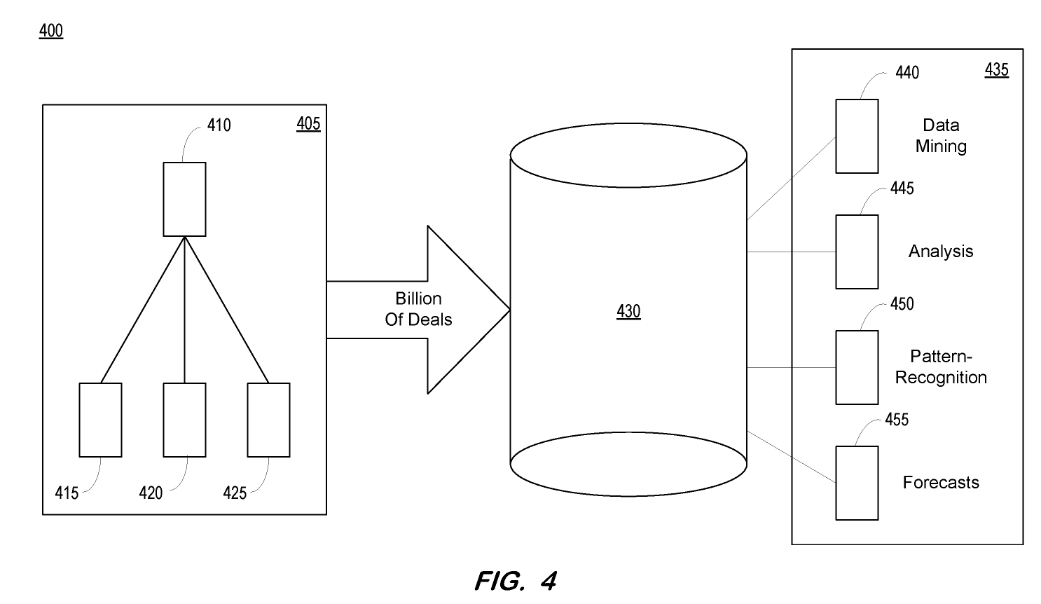

FIG. 4 is an illustrative depiction of an architecture or platform 400 supporting some of the methods and systems of some embodiments herein. Platform 400 includes one or more networked business platforms 405. The one or more networked business platforms may include a plurality of networked platforms 415, 420, and 425, where the networked business platforms can include procurement systems and other specific systems. In some embodiments, the plurality of (sub-) systems 415, 420, and 425 may be part of a networked business platform 410. Thousands of business entities may be members of the networked business platform 405 and these business entities might generate upwards of billions of transactions. The big data comprising the billions of transactions may primarily be non-public transaction information. The non-public transaction information can be stored and managed by a database system 430.

In some embodiments, communication between the database system 430 and the networked business platform 405 may be accomplished by one or more application program interfaces (APIs). In some embodiments, the APIs may be configured such that the networked business platform 405 need not be modified or at least minimally modified.

The non-public transaction information stored and managed by database system 430 may be analyzed in an effort to aid business entities belonging to a network where the members agree to share details of business transactions between them and others. In some aspects, the data analysis 435 can include, but not be limited to, data mining 440, analyses of different types 445, pattern recognition 450, and forecasts 455

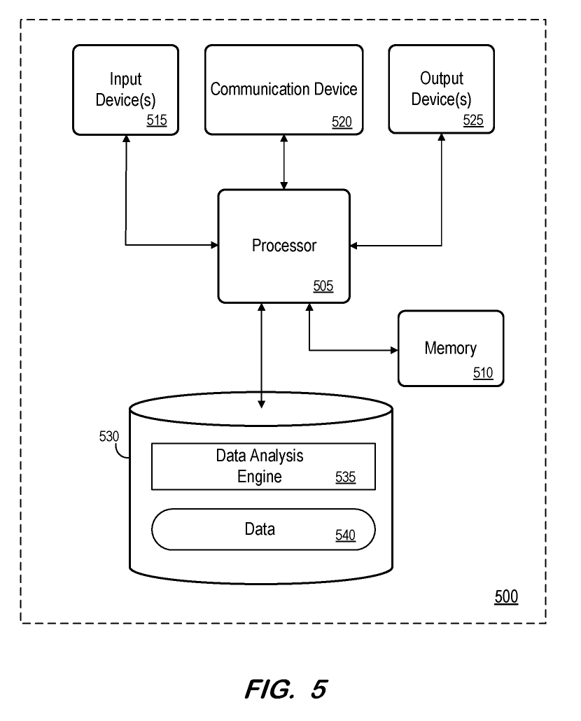

FIG. 5 is a block diagram of a system or apparatus 500 according to some embodiments. System 500 may be, for example, associated with devices for implementing a platform and or processes disclosed herein. System 500 comprises a processor 505, such as one or more commercially available Central Processing Units (CPUs) in the form of one-chip microprocessors or a multi-core processor, coupled to a communication device 520 configured to communicate via a communication network (not shown in FIG. 5) to another device or system. In the instance system 500 comprises a device or system, communication device 520 may provide a mechanism for system 500 to interface with an entity (e.g., an application, device, system, or service). System 500 may also include a cache 510, such as RAM memory modules. The system may further include an input device 515 (e.g., a touchscreen, mouse and/or keyboard to enter content) and an output device 525 (e.g., a touchscreen, a computer monitor to display, a LCD display).

Processor 505 communicates with a storage device 530. Storage device 530 may comprise any appropriate information storage device, including combinations of magnetic storage devices (e.g., a hard disk drive), optical storage devices, solid state drives, and/or semiconductor memory devices. In some embodiments, storage device 530 may comprise a cache management engine, including in some configurations an in-memory database.

Storage device 530 may store program code or instructions 535 that may provide processor executable instructions for analyzing the detailed transaction data, in accordance with processes herein. Processor 505 may perform the instructions of the program instructions for data analysis engine 535 to thereby operate in accordance with any of the embodiments described herein. Program instructions 535 may be stored in a compressed, uncompiled and/or encrypted format. Program instructions for data analysis engine 535 may furthermore include other program elements, such as an operating system, a database management system, and/or device drivers used by the processor 505 to interface with, for example, other systems, devices, and peripheral devices (not shown in FIG. 5). Storage device 530 may also include data 540. Data 540 may be used by system 500, in some aspects, in performing one or more of the processes herein, including individual processes, individual operations of those processes, and combinations of the individual processes and the individual process operations.

All systems and processes discussed herein may be embodied in program code stored on one or more tangible, non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Aspects of the processes, systems, and services discussed hereinabove may be implemented through any tangible implementation of one or more of tangible software, firmware, hardware, and combinations thereof, including processor executable instructions embodied on one or more types of media and executable by apparatuses including processors.

Although embodiments have been described with respect to certain contexts, some embodiments may be associated with other types of devices, systems, and configurations, either in part or whole, without any loss of generality.

The embodiments described herein are solely for the purpose of illustration. Those in the art will recognize other embodiments which may be practiced with modifications and alterations.

What is claimed is:

1. A method to provide a service to members enrolled with the service, the method comprising:
obtaining non-public transaction information concerning transactions between business trading entities belonging to a networked platform, the non-public transaction information including details of, at least, buying and selling of goods and services between the entities;
storing the non-public transaction information in a centrally accessible storage facility;
anonymizing the non-public transaction information;
analyzing the non-public transaction information based on, at least, an aggregation of the non-public transaction information; and
delivering a record of the analysis to members of a business network.

2. The method of claim 1, wherein the non-public transaction information is obtained from a plurality of networked platforms.

3. The method of claim 1, wherein the non-public transaction information includes data regarding all transactions between the business trading entities as known by the networked platform.

4. The method of claim 1, wherein the storage facility comprises an in-memory database.

5. The method of claim 1, wherein the analysis includes at least one of a data mining process, a forecasting process, and a pattern recognition process.

6. The method of claim 1, further comprising:
obtaining public market information concerning the transactions between the business trading entities;
storing the public market information in the centrally accessible storage facility; and
analyzing a combination of at least some of the aggregation of the non-public transaction information and at least some of the public market information.

7. The method of claim 1, wherein the delivery of the record of the analysis is limited to members of the business network.

8. A non-transitory computer-readable medium having processor-executable instructions stored thereon, the medium comprising:
instructions to obtain non-public transaction information concerning transactions between business trading entities belonging to a networked platform, the non-public transaction information including details of, at least, buying and selling of goods and services between the entities;
instructions to store the non-public transaction information in a centrally accessible storage facility;
instructions to anonymize the non-public transaction information;
instructions to analyze the non-public transaction information based on, at least, an aggregation of the non-public transaction information; and
instructions to deliver a record of the analysis to members of a business network.

9. The medium of claim 8, wherein the non-public transaction information is obtained from a plurality of networked platforms.

10. The medium of claim 8, wherein the non-public transaction information includes data regarding all transactions between the business trading entities as known by the networked platform.

11. The medium of claim 8, wherein the storage facility comprises an in-memory database.

12. The medium of claim 8, wherein the analysis includes at least one of a data mining process, a forecasting process, and a pattern recognition process.

13. The medium of claim 8, further comprising:
instructions to obtain public market information concerning the transactions between the business trading entities;
instructions to store the public market information in the centrally accessible storage facility; and
instructions to analyze a combination of at least some of the aggregation of the non-public transaction information and at least some of the public market information.

14. The medium of claim 8, wherein the delivery of the record of the analysis is limited to members of the business network.
